(19) United States
(12) Patent Application Publication
(10) Pub. No.: US 2022/0405945 A1
(43) Pub. Date: Dec. 22, 2022

(54) Method, Device And Non-Transitory Computer-Readable Storage Medium For Processing A Sequence Of Top View Image Frames

(71) Applicant: Kayrros, Paris (FR)

(72) Inventors: Ngoc-Long Nguyen, Palaiseau (FR); Jérémy Anger, Bourg-La-Reine (FR); Axel Davy, Palaiseau (FR); Pablo Arias Martinez, Barcelona (ES); Gabriele Facciolo, Cachan (FR)

(73) Assignee: Kayrros, Paris (FR)

(21) Appl. No.: 17/842,996

(22) Filed: Jun. 17, 2022

Related U.S. Application Data
(60) Provisional application No. 63/211,628, filed on Jun. 17, 2021.

(51) Int. Cl. G06T 7/246; G06T 9/00; G06T 7/73

(52) U.S. Cl. CPC G06T 7/248; G06T 9/002; G06T 7/74; G06T 2207/10032; G06T 2207/20084; G06T 2207/20081

(57) ABSTRACT

The invention relates to a method for processing a sequence of top view image frames ({Iₜ^{LR}}ₜ₌₀^{T}) of low resolution of a same terrestrial location, each top view image frame ({Iₜ^{LR}}ₜ₌₀^{T}) having pixels and pixel values, comprising the following steps:
choosing (S0) one top view image frame (I₀^{LR}), called reference frame (I₀^{LR}), among the top view image frames ({Iₜ^{LR}}ₜ₌₀^{T}),
estimating (S1) motion fields (F_{t→0}, ME) between each top view image frame ({Iₜ^{LR}}ₜ₌₁^{T}) and the reference frame (I₀^{LR}) by using a first neural network (NN1),
encoding (S1′) the top view image frames ({Iₜ^{LR}}ₜ₌₁^{T}) to produce convolutional features ({Jₜ^{LR}}ₜ₌₁^{T}) extracted respectively from the top view image frames ({Iₜ^{LR}}ₜ₌₁^{T}) by using a second neural network (NN2),
aggregating (S2, S3, Shift-and-add, SPMC) pixels of the convolutional features ({Jₜ^{LR}}ₜ₌₁^{T}) to positions ({Jₜ^{HR}}ₜ₌₁^{T}) in a high resolution grid (HRG) using the motion fields (F_{t→0}, ME) to obtain aggregated features (J^{HR}),
decoding (S4) by a decoder network (DN) the aggregated features (J^{HR}) to produce a super-resolved image (Î₀^{SR}).

### BACKGROUND OF THE INVENTION

The invention concerns a method a device and a computer-readable storage medium for processing a sequence of top view image frames of a same terrestrial location.

A field of application of the invention is earth monitoring, for example for the detection of human activity or of any activity.

One goal of the invention is to improve resolution of images taken by satellites or other overhead image acquisition devices.

High resolution satellite imagery is key for applications such as monitoring human activity or disaster relief. In recent years, computational super-resolution is being adopted as a cost-effective solution to increase the spatial resolution of satellite images.

Super-resolution approaches can be broadly classified into single-image (SISR) and multi-image (MISR). SISR is a severely ill-posed problem. In fact, during the acquisition of the low-resolution (LR) images, some high-frequency components are lost or aliased, hindering their correct reconstruction. As a consequence, SISR methods attempt to generate plausible reconstructions compatible with the LR image, rather than to recover the real high resolution (HR) image. In contrast, MISR aims at exploiting the alias to retrieve the true details in the super-resolved image (SR) by combining the non-redundant information from multiple LR observations.

Especially MISR from push-frame satellite sensors such as the SkySat constellation from Planet are considered. The invention is also applicable to other push-frame satellite constellation, such as the constellation from Satellogic. The SkySat satellites contain a full-frame sensor capable of capturing bursts of overlapping frames. So the same point on the ground is seen in several consecutive images. Furthermore, thanks to the design of its optical system, the images are aliased, which is an ideal setting for MISR.

In the context of satellite imaging, since the sensor is far from the ground, it is often assumed that the observed scene lies on a plane at infinity. This allows to consider a simplified model for the formation of the low-resolution images Iₜ^{LR}

Iₜ^{LR}=ΠAₜ( [symbol] *k)+nₜ,

where [symbol] denotes the infinite-resolution ideal image, k is the Point Spread Function (PSF) modeling jointly optical blur and pixel integration, Aₜ is a homographic transformation (often approximated by an affine one), Π is the bi-dimensional sampling operator due to the sensor array, and nₜ models the image noise. The model should write (Aₜ [symbol] )*k, but in the specific case of rigid transformations, assuming that k is an isotropic kernel, Aₜ and k commute.

Because of the spectral decay imposed by the pixel integration and optical blur (k), the image [symbol] ^{bl}:= [symbol] *k is band limited. For SkySat, the frequency cutoff is at about twice the sampling rate of the LR images. This implies that there is no usable high frequency information beyond the 2× zoom factor. Our goal in this work to increase the resolution by a factor of 2, by estimating I^{HR}, a non-aliased sampling of [symbol] ^{bl} from several discrete observations Iₜ^{LR}. A sharper super-resolved image can also be recovered by partially deconvolving k. Aggregating many frames is also interesting as it allows to greatly reduce the noise.

Lately, deep learning algorithms have proven a success in super-resolution. Data-driven methods can incorporate realistic image priors leading to improved restoration using fewer input images. However, these methods are data-hungry and they heavily rely on the size and quality of the training dataset. The importance of training SISR algorithms with realistic data was highlighted, where it was shown that models trained on synthetic data generalized poorly to a dataset of real pairs of LR/HR images.

MISR datasets with real data are usually small and can only be used as test sets for benchmarking (for example the MDSP dataset). An exception is the PROBA-V dataset, which allows to train supervised deep-learning MISR methods on real-world satellite images. This is a rare case as the PROBA-V satellite is equipped with two cameras with different resolutions. However, the images in the PROBA-V datasets are unsuitable for training MISR methods for image bursts acquired at a high frame rate, as the LR image sequences are multi-date and present significant content and illumination changes.

Due to this lack of datasets with real LR/HR images, most deep learning MISR algorithms are trained on simulated data. Good results in denoising of real images have been obtained using synthetic datasets. However, this requires a careful modeling of the imaging systems, which is not straightforward for complex satellite sensors.

A similar problem affects other video restoration problems. Recent works have proposed to train video denoising and demosaicking networks with self-supervised learning by exploiting the temporal redundancy in videos. In these works, the network is trained to predict a frame of a noisy sequence using its neighboring frames, eliminating the need for ground truth.

### SUMMARY OF THE INVENTION

A first subject matter of the invention is a method for processing a sequence of top view image frames of low resolution of a same terrestrial location, each top view image frame having pixels and pixel values, comprising the following steps:

choosing one top view image frame, called reference frame, among the top view image frames,

estimating motion fields between each top view image frame and the reference frame by using a first neural network,

encoding the top view image frames to produce convolutional features extracted respectively from the top view image frames by using a second neural network,

aggregating pixels of the convolutional features to positions in a high resolution grid using the motion fields to obtain aggregated features,

decoding by a decoder network the aggregated features to produce a super-resolved image.

A second subject matter of the invention is a device for processing a sequence of top view image frames of low resolution of a same terrestrial location, each top view image frame having pixels and pixel values, comprising:

a calculator to choose one top view image frame, called reference frame, among the top view image frames,

a first neural network for estimating motion fields between each top view image frames and the reference frame,

a second neural network for encoding the top view image frames to produce convolutional features extracted respectively from the top view image frames,

the calculator being configured to aggregate pixels of the convolutional features to positions in a high resolution grid using the motion fields to obtain aggregated features,

a decoder network for decoding the aggregated features to produce a super-resolved image.

A third subject matter of the invention is a non-transitory computer-readable storage medium having instructions thereon that, when executed by a processor, cause the processor to execute operations for processing a sequence of top view image frames of low resolution of a same terrestrial location, each top view image frame having pixels and pixel values, the operations comprising

choosing one top view image frame, called reference frame, among the top view image frames,

estimating motion fields between each top view image frames and the reference frame by using a first neural network,

encoding the top view image frames to produce convolutional features extracted respectively from the top view image frames by using a second neural network,

aggregating pixels of the convolutional features to positions in a high resolution grid using the motion fields to obtain aggregated features,

decoding by a decoder network the aggregated features to produce a super-resolved image.

According to one aspect of the invention, a framework for self-supervised training of MISR networks without requiring high resolution ground truth images is provided.

The invention can be applied to neural networks that include an explicit motion compensation module. One of the LR frames is set as reference. During training, the reference is only viewed by the motion compensation module (to align the rest of the LR frames) but is withheld from the rest of the network. The network is tasked to predict a super-resolved image which, when downsampled, coincides with the withheld reference frame.

As an additional contribution, another aspect of the invention provides a novel MISR architecture, Deep Shift-and-Add (DSA), consisting of a shift-and-add fusion of features. The DSA network accepts a variable number of input frames and is invariant to their order. This allows us to use all available LR frames at test time (including the reference LR frame), which improves the performance.

Experiments conducted on synthetic data show that the DSA network trained with the proposed self-supervision strategy attains state-of-the-art results on par with those obtained with a supervised training. This is the first method that trains a MISR CNN without supervision. In addition, the proposed method reduces noise, successfully handles degenerate samplings and can integrate the final deconvolution step.

The framework makes it possible to train a network on datasets of real LR images. We demonstrate this by training the DSA network on a novel public dataset of real image bursts from SkySat satellites. In a qualitative comparison, we see that the obtained results are more resolved and less noisy than the L1B product from Planet.

### DESCRIPTION OF THE DRAWINGS

The invention will be more clearly understood from the following description, given solely by way of non-limiting example in reference to the appended drawings, in which:

FIG. 1 schematically illustrates an image (a) processed according to the state of the art (b) and according to an embodiment of the invention (c).

FIG. 2a schematically illustrates an example of a device for processing a sequence of top view image frames according to an embodiment of the invention.

FIG. 2b schematically illustrates how pixels are shifted and further subpixels are added according to a feature of the device and method according to an embodiment of the invention.

FIG. 3a schematically illustrates uniform sampling of an image.

FIG. 3b schematically illustrates degenerate sampling of an image

FIG. 4 schematically illustrates the PSNR of methods the state of the art and of embodiments of the invention.

FIG. 5 schematically illustrates an image processed according to the state of the art and according to an embodiment of the invention.

FIG. 6 schematically illustrates an image processed according to the state of the art and according to an embodiment of the invention.

FIG. 7 schematically illustrates an image processed according to the state of the art and according to an embodiment of the invention.

FIG. 8 shows steps of the method for processing images according to embodiments of the invention.

### DETAILED DESCRIPTION OF THE INVENTION

### Images Taken

The present disclosure relates to a method and system for creating a super-resolved image u_{b} (e.g., an image obtained by super-resolution processing) of a given scene from one or more images zⱼ (e.g., a sequence of respective images {Iₜ^{LR}}ₜ₌₀^{T} or frames {Iₜ^{LR}}ₜ₌₀^{T}) that each depict the same scene, i.e. the same terrestrial location, and which are said to be low resolution images. The images {Iₜ^{LR}}ₜ₌₀^{T} may be respective top view images {Iₜ^{LR}}ₜ₌₀^{T}. In the method, consecutive frames (i.e. consecutive images {Iₜ^{LR}}ₜ₌₀^{T}) of a video are used as input, and one or more images zⱼ showing the same scene as the input images are produced from the input images {Iₜ^{LR}}ₜ₌₀^{T} with a spatial resolution improved. The number of images output by the method may be equal to or less than the number of input images {Iₜ^{LR}}ₜ₌₀^{T}. For example, the same scene, or same terrestrial location in the images {Iₜ^{LR}}ₜ₌₀^{T} may be obtained from a media, in which the images are registered. The images {Iₜ^{LR}}ₜ₌₀^{T} are obtained by an image production module, which may be a computer or any automatic machine, able to download the images from the media. The media may be an external media, which may be a database, a distant server, a website, a distant computer or others. The media may be a local media, such as memory or storage media, for example of the image production module.

The respective top view images {Iₜ^{LR}}ₜ₌₀^{T} are images {Iₜ^{LR}}ₜ₌₀^{T} which have been previously acquired from at least one overhead image acquisition device and which may have been stored in the media. The respective top view images {Iₜ^{LR}}ₜ₌₀^{T} may be satellite images {Iₜ^{LR}}ₜ₌₀^{T}, or aerial images {Iₜ^{LR}}ₜ₌₀^{T}. The image acquisition device may be one or more satellites, using photographic sensors. The respective top view images {Iₜ^{LR}}ₜ₌₀^{T} may also be aerial images {Iₜ^{LR}}ₜ₌₀^{T}, taken from a plane or a drone, using photographic sensors. In some embodiments, the image acquisition device acquires a set of respective top view images {Iₜ^{LR}}ₜ₌₀^{T} that depict the same scene. Such an image acquisition device may obtain images {Iₜ^{LR}}ₜ₌₀^{T} from an elevated position such as a position in space or sky. In some embodiments, the acquisition of the images {Iₜ^{LR}}ₜ₌₀^{T} is obtained from a single image acquisition device, which may be a satellite, a drone, a plane, a dirigible, a balloon, or any other overhead device. The respective top view images {Iₜ^{LR}}ₜ₌₀^{T} acquired possibly may be taken from multiple viewpoints and stored as separate images or as a video. The overhead imaging device may comprise (e.g., embed) an optical system (e.g., an onboard device). The optical system may have a concentrated point spread function and may not apply any anti-aliasing filter. The aliased images {Iₜ^{LR}}ₜ₌₀^{T} inherently possess the information required for the recovery of super-resolved images.

The overhead image acquisition device may be moving relatively to the scene or terrestrial location, as indicated for the examples mentioned above, which create the different viewpoints of the scene or terrestrial location in the images. Furthermore, the different viewpoints can be caused by the motion of the optical system acquiring the images within the overhead image acquisition device. The motion of the optical system within the overhead image acquisition device may be caused by undesirable moving or undesirable wobbling of the optical system acquiring the images or of an actuator of the optical system relatively to the overhead image acquisition device, which can be itself moving or not moving relatively to the scene or terrestrial location. Since the image acquisition cannot be perfectly controlled, neither can the sampling be optimal. Since the overhead image acquisition device is moving while acquiring the respective top view images {Iₜ^{LR}}ₜ₌₀^{T}, small exposure times may be necessary to avoid blur, thus the images are noisy.

The images zⱼ can be acquired with different modalities and with any visible or infrared wavelength (visible, VNIR, NIR, SWIR, etc.). In one implementation, the acquisition time may vary from one image {Iₜ^{LR}}ₜ₌₀^{T} to the next. This mechanism allows for the reconstruction of high dynamic range images. The acquisition process can also be controlled so as to improve the sampling geometry which is used for super-resolution.

The method may comprise registering the respective top view images {Iₜ^{LR}}ₜ₌₀^{T}, which collectively form a set of images.

In the description below, the images are called top view image frames {Iₜ^{LR}}ₜ₌₀^{T} ({Iₜ^{LR}}ₜ₌₀^{T}) of low resolution of a same terrestrial location.

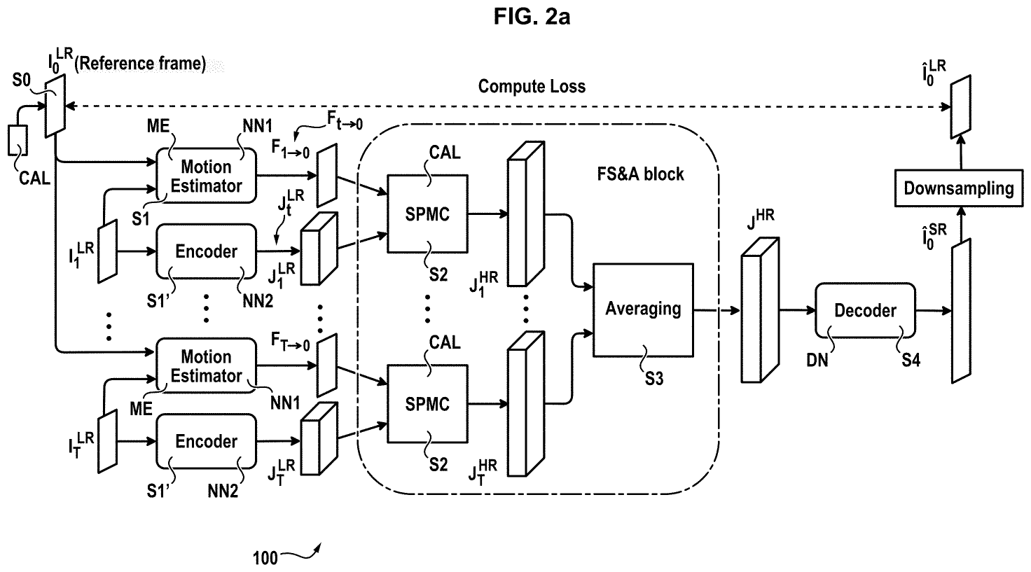

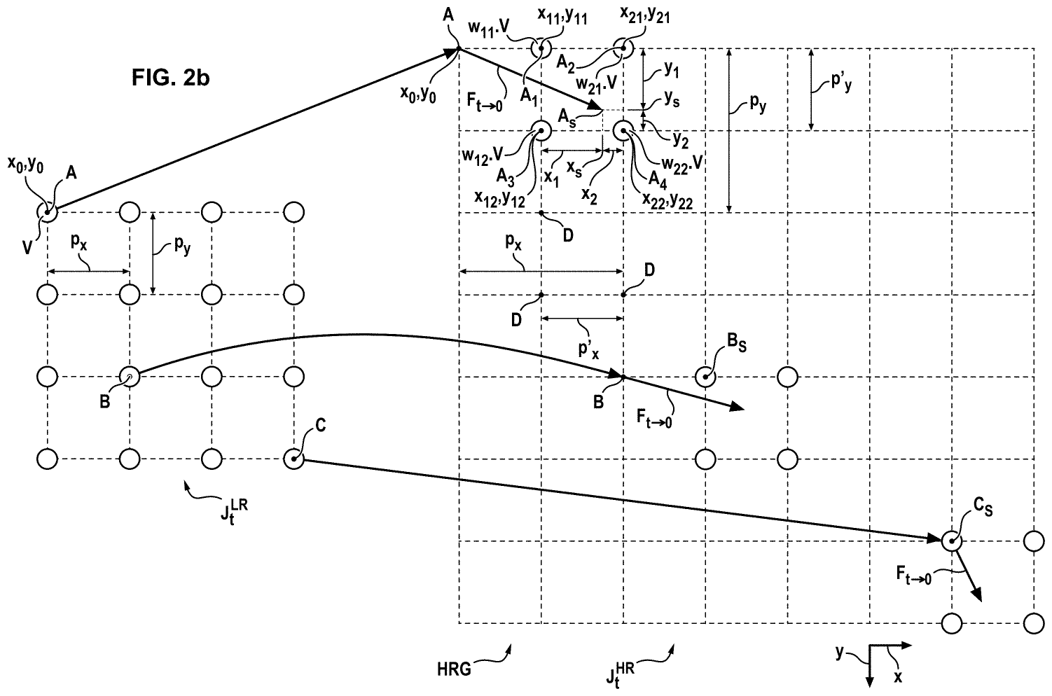

Embodiments of the invention are described below and examples of steps of the method for processing the respective top view images are described below in reference to FIGS. 2a, 2b and 8.

A processing device 100 for processing the top view image frames {Iₜ^{LR}}ₜ₌₀^{T} to carry out the method(s) is also provided, as shown on FIG. 2a. The device 100 and method may be embodied by any means, such as for example computers, calculators, processors, microprocessors, permanent memories, servers, databases, computer programs, man-machine interfaces, user interfaces, network, framework, neural networks. The device 100 may comprise means to carry out the steps and operations mentioned of the method of the invention, with these means which can be computers, calculators, processors, microprocessors, graphics processing units, memories, permanent memories, servers, databases, computer programs, man-machine interfaces, user interfaces. Computer programs according to the invention may comprise instructions for executing the steps and operations of the method(s). The computer program may be recorded on any storage media, which may be permanent storage memory, i.e. a non-transitory computer-readable storage medium, or a non-permanent storage memory.

According to one aspect of the invention, there is provided a method for processing a sequence of top view image frames {Iₜ^{LR}}ₜ₌₀^{T} of low resolution of a same terrestrial location, each top view image frame {Iₜ^{LR}}ₜ₌₀^{T} having pixels and pixel values, comprising the following steps:

choosing (in a step S0) one top view image frame I₀^{LR}, called reference frame I₀^{LR}, among the top view image frames {Iₜ^{LR}}ₜ₌₀^{T}, estimating (in a step S1) motion fields F_{t→0} (ME) between each top view image frames {Iₜ^{LR}}ₜ₌₁^{T} and the reference frame I₀^{LR} by using a first neural network NN1,

encoding (in a step S1′) the top view image frames {Iₜ^{LR}}ₜ₌₁^{T} to produce convolutional features {Jₜ^{LR}}ₜ₌₁^{T} extracted respectively from the top view image frames {Iₜ^{LR}}ₜ₌₁^{T} by using a second neural network NN2,

aggregating (in steps S2, S3, Shift-and-add, by the Subpixel Motion Compensation layer SPMC) pixels of the convolutional features {Jₜ^{LR}}ₜ₌₁^{T} to positions {Jₜ^{LR}}ₜ₌₁^{T} in a high resolution grid HRG using the motion fields F_{t→0} to obtain aggregated features J^{HR},

decoding (in a step S4) by a decoder network DN the aggregated features J^{HR} to produce a super-resolved image Î₀^{SR}.

According to one aspect of the invention, there is provided a device 100 for processing the sequence of top view image frames {Iₜ^{LR}}ₜ₌₀^{T} of low resolution of a same terrestrial location, each top view image frame {Iₜ^{LR}}ₜ₌₀^{T} having pixels and pixel values, the device 100 comprising:

a calculator CAL to choose (in step S0) one top view image frame I₀^{LR}, called reference frame I₀^{LR}, among the top view image frames {Iₜ^{LR}}ₜ₌₀^{T},

the first neural network NN1 for estimating (in step S1) the motion fields F_{t→0}, (motion estimator ME) between each top view image frames {Iₜ^{LR}}ₜ₌₀^{T} and the reference frame I₀^{LR},

a second neural network NN2 for encoding (in step S1′) the top view image frames {Iₜ^{LR}}ₜ₌₁^{T} to produce the convolutional features {Jₜ^{LR}}ₜ₌₁^{T} extracted respectively from the top view image frames {Iₜ^{LR}}ₜ₌₁^{T},

the calculator CAL being configured to aggregate (in steps S2, S3, Shift-and-add, by the Subpixel Motion Compensation layer SPMC) pixels of the convolutional features {Jₜ^{LR}}ₜ₌₁^{T} to the positions {Jₜ^{HR}}ₜ₌₁^{T} in the high resolution grid HRG using the motion fields F_{t→0} to obtain the aggregated features J^{HR},

the decoder network DN for decoding (in step S4) the aggregated features J^{HR} to produce the super-resolved image iÎ₀^{SR}.

The decoder network DN may be a neural network DN.

According to one aspect of the invention, there is provided a non-transitory computer-readable storage medium having instructions thereon that, when executed by a processor, cause the processor to execute operations for processing the sequence of top view image frames {Iₜ^{LR}}ₜ₌₀^{T} of low resolution of a same terrestrial location, each top view image frame {Iₜ^{LR}}ₜ₌₀^{T} having pixels and pixel values, the operations comprising

choosing (in step S0) one top view image frame I₀^{LR}, called reference frame I₀^{LR}, among the top view image frames {Iₜ^{LR}}ₜ₌₀^{T},

estimating (in step S1) the motion fields F_{t→0} (ME) between each top view image frames {Iₜ^{LR}}ₜ₌₁^{T} and the reference frame (I₀^{LR} by using the first neural network NN1,

encoding (in step S1′) the top view image frames {Iₜ^{LR}}ₜ₌₁^{T} to produce the convolutional features {Jₜ^{LR}}ₜ₌₁^{T} extracted respectively from the top view image frames {Iₜ^{LR}}ₜ₌₁^{T} by using the second neural network NN2,

aggregating (in steps S2, S3, Shift-and-add, by the Subpixel Motion Compensation layer SPMC) pixels of the convolutional features {Jₜ^{LR}}ₜ₌₁^{T} to the positions {Jₜ^{LR}}ₜ₌₁^{T} in the high resolution grid HRG using the motion fields F_{t→0} (ME) to obtain the aggregated features J^{HR},

decoding (in step S4) by the decoder network DN the aggregated features J^{HR} to produce the super-resolved image Î₀^{SR}.

As shown on FIG. 2a, there are for example T+1 top view image frames {Iₜ^{LR}}ₜ₌₀^{T}, wherein T is an integer higher than 0, wherein t is positive integer going from 0 to T, and T is a prescribed integer. In step S1, for t=1 to T, the motion fields F_{1→0} . . . F_{T→0} between respectively the top view image frames I₁^{LR} . . . I_{T}^{LR} and the reference frame I₀^{LR} are estimated by using the first neural network NN1. As shown on FIG. 2a, in step S2, for t=1 to T, the positions {Jₜ^{LR}}ₜ₌₁^{T} in the high resolution grid HRG using the motion fields F_{1→0} . . . F_{T→0} are computed.

The device and method using neural network take as input the sequence of LR images {Iₜ^{LR}}ₜ₌₀^{T} and produce one super-resolved image Î₀^{SR}. In an embodiment, the architecture uses a shift-and-add MISR algorithm in steps S2 and S3, especially those that perform a weighted average of the aligned LR image samples depending on their subpixel positions.

The motion fields F_{t→0} between all the LR frames {Iₜ^{LR}}ₜ₌₁^{T} in the burst and a reference one I₀^{LR} are first estimated with the trainable motion estimation module NN1 in step S1. Then, according to an embodiment, the frames are upscaled and aligned by compensating the motion using the Subpixel Motion Compensation layer (SPMC) in step S2. The SPMC layer is applied to the convolutional features Hₜ^{LR} extracted from the frames Iₜ^{LR}, as it has been shown that deep feature representations encode at each pixel a rich description of the local neighborhood. The upscaled and aligned features Jₜ^{HR} are then averaged in a high resolution feature map J^{HR} in step S3. The Super-Resolved image image Î₀^{SR} is then obtained by decoding J^{HR} in step S4. In summary, the action of the network can be described in three steps: encoding S1′, temporal feature aggregation S2, S3, and decoding S4. The temporal aggregation is done simply by feature averaging, via a feature shift-and-add block (FS [symbol] A block in FIG. 2a). This schema allows to aggregate an arbitrary number of frames and is permutation invariant.

In step S1′, N features are produced by the neural network NN2 for each top view image frame Iₜ^{LR}}ₜ₌₁^{T}. N is a prescribed integer higher than or equal to 1, for example higher than or equal to 2. For example, N=64.

The trainable modules NN1, NN2, DN of the proposed architecture include the Motion Estimator ME, the Encoder and the Decoder.

### Motion Estimator

The network ME is built to estimate the optical flows F_{t→0} between each LR frame {Iₜ^{LR}}ₜ₌₁^{T} and the reference frame I₀^{LR} for t=1 to T in step S1,

F_{t→0}=ME(Iₜ^{LE},I₀^{LE};Θ_{ME})∈[−R,R]^{H×W×2}.

The parameters of the Motion Estimator ME are denoted θ_{ME}. This network will be trained with a maximum range of motions [−R, R]² (in this work, R=5 pixels for example). R is the absolute value of the maximum range of motions and is prescribed. H is a prescribed height in the LR frame {Iₜ^{LR}}ₜ₌₁^{T}. W is a prescribed width in the LR frame {Iₜ^{LR}}ₜ₌₁^{T}.

In an embodiment, the neural network NN1 of the motion estimator ME may follow a simple hourglass style architecture.

According to an embodiment, the method comprises filtering beforehand the top view image frame {Iₜ^{LR}}ₜ₌₀^{T} and the reference frame I₀^{LR} by a Gaussian filter. This reduces the alias. This filtering is made during step S-1 before the steps S0, S1, S1′, S2, S3 and S4.

In an example, the neural network NN1 may comprise 4 first scales with successively 32, 64, 128 and 256 features being estimated in the first scales, each first scale having 2 first convolution layers. The first scales are separated by a Maxpooling block. Blocks of LeakyRelu(0.2)(x)=max(x, 0.2x) are provided after each convolution layer in each first scale.

The neural network NN1 may comprise 3 second scales with successively 128, 64 and 32 features being estimated in the second scales, each second scale having 2 second convolution layers. The second scales are separated by a bilinear up-sampling layer. Blocks of LeakyRelu(x)=max(x, 0.2x) are provided after each convolution layer in each second scale.

More complex methods can be adopted, but since in our application, the apparent motion is mainly caused by the motion of the satellite, a smooth motion estimate suffices.

### Encoder

In step S1′, the Encoder having the neural network NN2 generates the relevant features (Jₜ^{LR})ₜ₌₁^{T} for each LR image {Iₜ^{LR}}ₜ₌₁^{T} in the sequence

Jₜ^{LR}=Encoder(Iₜ^{LR};Θ_{E})∈ [symbol] ^{H×W×N},

where Θ_{E} is the set of parameters of the encoder. N is the number of produced features for each low resolution image frame Iₜ^{LR} and is a prescribed integer. In an example N=64. In an example, the network NN2 comprises 2 convolutional layers at the two ends of a series of 4 residual blocks with N=64 features per layer. Each residual block has 2 other convolutional layer supplying N=64 features and supplies an output being equal to its input added to the 2 other convolutional layers applied to this input.

### Shift-And-Add, SPMC

According to an embodiment, step S2 comprises a MISR architecture consisting of a shift-and-add fusion of features.

According to an embodiment, in step S2, aggregating the pixels comprises computing the positions {Jₜ^{HR}}ₜ₌₁^{T} in the high resolution grid (HRG) from the motion fields F_{t→0} and from the pixels A of the convolutional features {Jₜ^{LR}}ₜ₌₁^{T}.

An example of such positions and of a shifting explained below for pixels A, B, C of the convolutional features {Jₜ^{LR}}ₜ₌₁^{T} is given in FIG. 2b, to obtain respectively shifted pixels Aₛ, Bₛ, Cₛ in the high resolution grid HRG. Below the shifting is explained in reference to pixel A.

According to an embodiment, in step S2, aggregating the pixels comprises computing the positions {Jₜ^{HR}}ₜ₌₁^{T} in the high resolution grid HRG as subpixel positions A₁, A₂, A₃, A₄ relatively to the pixels A of the convolutional features ({Jₜ^{LR}}ₜ₌₁^{T} ).

According to an embodiment, in step S2, aggregating the pixels comprises comprises:

upscaling the convolutional features {Jₜ^{LR}}ₜ₌₁^{T} of each top view image frame {Iₜ^{LR}}ₜ₌₁^{T}, by adding second subpixel positions D having zero values between at least some of the pixels of the convolutional features {Jₜ^{LR}}ₜ₌₁^{T} in the high resolution grid HRG.

According to an embodiment, in step S2, aggregating the pixels comprises computing the subpixel positions A₁, A₂, A₃, A₄ as being the closest from the pixels Aₛ of the convolutional features {Jₜ^{LR}}ₜ₌₁^{T} having been shifted by the motion fields F_{t→0} in the high resolution grid HRG.

According to an embodiment, in step S2, aggregating the pixels comprises

computing (in step S3) subpixel values V₁, V₂, V₃, V₄ at the subpixel positions A₁, A₂, A₃, A₄ in the high resolution grid HRG,

wherein for each pixel A of the convolutional features {Jₜ^{LR}}ₜ₌₁^{T} the subpixel value V₁, V₂, V₃, V₄ at the subpixel positions A₁, A₂, A₃, A₄ is a weighted average w₁₁·V, w₂₁·V, w₁₂·V, w₂₂·V of a value V of the pixel A of the convolutional features {Jₜ^{LR}}ₜ₌₁^{T},

computing the aggregated features J^{HR} depending on the weighted average w₁₁·V, w₂₁·V, w₁₂·V, w₂₂·V.

It means for pixel A that in the high resolution grid HRG:

V₁=w₁₁·V at subpixel position A₁,

V₂=w₂₁·V at subpixel position A₂,

V₃=W₁₂·V at subpixel position A₃,

V₄=w₂₂·V at subpixel position A₄.

According to an embodiment, the method comprises computing (in step S3) the weighted average w₁₁·V, w₂₁·V, w₁₂·V, w₂₂·V, of the value V of the pixel A of the convolutional features {Jₜ^{LR}}ₜ₌₁^{T} at each subpixel position A₁, A₂, A₃, A₄ of the high resolution grid HRG using prescribed bilinear weights w₁₁, w₂₁, w₁₂, w₂₂, which are applied to the value V of the pixel A of the convolutional features {Jₜ^{LR}}ₜ₌₁^{T} and which are calculated depending on a distance d₁, d₂, d₃, d₄ calculated between the pixels Aₛ of the convolutional features {Jₜ^{LR}}ₜ₌₁^{T} having been shifted by the motion fields F_{t→0}, ME in the high resolution grid HRG and the subpixel position A₁, A₂, A₃, A₄.

According to an embodiment, the method comprises calculating (in step S3) the prescribed bilinear weights w₁₁, w₂₁, w₁₂, w₂₂ as being a decreasing function of the distance d₁, d₂, d₃, d₄ calculated between the pixels Aₛ of the convolutional features {Jₜ^{LR}}ₜ₌₁^{T} having been shifted by the motion fields F_{t→0}, ME in the high resolution grid HRG and the subpixel position A₁, A₂, A₃, A₄ in the high resolution grid HRG.

According to an embodiment, for each pixel A of the convolutional features {Jₜ^{LR}}ₜ₌₁^{T} the subpixel positions A₁, A₂, A₃, A₄ comprise:

a first subpixel position A₁ having in the high resolution grid HRG a first abscisssa x₁₁ and a first ordinate y₁₁,

a second subpixel position A₂ having in the high resolution grid HRG a second abscisssa x₂₁, which is equal to the first abscisssa x₁₁ plus an abscissa pitch p′ₓ of the high resolution grid HRG, and a second ordinate y₂₁, which is equal to the first ordinate y₁₁,

a third subpixel position A₃, having in the high resolution grid HRG a third abscisssa x₁₂, which is equal to the first abscisssa x₁₁, and a third ordinate y₁₂, which is equal to the first ordinate y₁₁ plus the ordinate pitch p′_{y},

a fourth subpixel position A₄, having in the high resolution grid HRG a fourth abscisssa x₂₂, which is equal to the first abscisssa x₁₁ plus the abscissa pitch p′ₓ, and a fourth ordinate y₂₂, which is equal to the first ordinate y₁₁ plus the ordinate pitch p′_{y},

each pixel Aₛ of the convolutional features {Jₜ^{LR}}ₜ₌₁^{T} having been shifted by the motion fields F_{t→0} in the high resolution grid HRG having a fifth abscisssa xₛ and a fifth ordinate yₛ,

wherein

w₁₁=x₂/(2·p′ₓ)+y₂/(2·p′_{y})

w₂₁=x₁/(2p′ₓ)+y₂/(2·p′_{y})

w₁₂=x₂/(2·p′ₓ)+y₁/(2·p′_{y})

w₂₂=x₁/(2·p′ₓ)+y₁/(2·p′_{y})

x₁=xₛ−x₁₁

x₂=x₂₁−xₛ

y₁=yₛ−y₁₁

y₂=y₂₁−yₛ.

It follows that:

p′ₓ=x₁+x₂

p′_{y}=y₁+y₂

w₁₁+w₁₂+w₂₁+w₂₂=1

with 0≤x₁≤p′ₓ,

0≤x₂≤p′ₓ,

0≤y₁≤p′ₓ,

0≤y₂≤<p′ₓ.

For example, p′ₓ=pₓ/2 and p′_{y}=p_{y}/2, in the case that the upscaling factor r=2, wherein pₓ is an abscissa pitch of the pixels A in the convolutional features {Jₜ^{LR}}ₜ₌₁^{T}, and p_{y} is an ordinate pitch of the pixels A in the convolutional features {Jₜ^{LR}}ₜ₌₁^{T}.

In a more general manner, the upscaling factor r of the positions {Jₜ^{HR}}ₜ₌₁^{T} in the high resolution grid HRG (i.e. of the subpixel positions A₁, A₂, A₃, A₄) relatively to the pixels A of the convolutional features {Jₜ^{LR}}ₜ₌₁^{T} is an integer higher than 2 or equal to 2.

p′ₓ=pₓ/r along the first direction x and and p′_{y}=p_{y}/r along the second direction y perpendicular to the first direction x. pₓ may be equal to p_{y} or may be equal to p_{y}.

In another example, r=3 may be provided.

A shift-and-add process is used to map and aggregate the pixels A of the features {Jₜ^{LR}}ₜ₌₁^{T} to their positions A₁, A₂, A₃, A₄ in the high resolution grid HRG using the corresponding optical flows. We separate the process in two: first the features of each frame are upscaled by introducing zeros between samples and motion compensated with the SPMC module in step S2, then the weighted average is computed in step S3.

The SPMC module uses the flow F_{t→0} to compute the positions of the samples from Jₜ^{LR} in the high resolution grid HRG

Jₜ^{HR}=SPMC(Jₜ^{LR},{F_{t→0}})∈ [symbol] ^{rH×rW×N},

where r is the upscaling factor. Every low resolution pixel of the features {Jₜ^{LR}}ₜ₌₁^{T} is “splattered” on a neighborhood of the computed high resolution position {Jₜ^{HR}}ₜ₌₁^{T} using the bilinear weights w₁₁, w₂₁, w₁₂, w₂₂. In this way, the operation is differentiable with respect to both the intensities (pixel values) and the optical flows F_{t→0}.

According to an embodiment, the method comprises computing the aggregated features J^{HR} being proportional to the weighted average w₁₁·V, w₂₁·V, w₁₂·V, w₂₂·V.

According to an embodiment, the method comprises computing (in step S3) the aggregated features J^{HR} as

J^{HR}=(ΣₜJₜ^{HR})(ΣₜWₜ^{HR})⁻¹

wherein Wₜ^{HR}=SPMC(1,{F_{t→0}}) are the sum of the prescribed bilinear weights affecting the values V of the pixels of the convolutional features {Jₜ^{LR}}ₜ₌₁^{T}. Such aggregation is a weighted aggregation.

In an embodiment, the shift-and-add block (FS [symbol] A block in FIG. 2a) does not have any trainable parameters.

The step S3 produces the aggregated features J^{HR} from the positions Jₜ^{HR} and their weighted average for the N features {Jₜ^{LR}}ₜ₌₁^{T}. The aggregation is performed along the temporal dimension t=1 to N. In step S3, each group of N subpixels in the positions Jₜ^{HR} corresponding respectively to the N features {Jₜ^{LR}}ₜ₌₁^{T} are each aggregated into one pixel in the image J^{HR}. Consequently, the features J^{HR} have a number of pixels equal to (px/p′x) multiplied by the number of pixels of the low resolution image frame Iₜ^{LR} in the x direction (width), multiplied by a number of pixels equal to (py/p′y) multiplied by the number of pixels of the frame Iₜ^{LR} in the y direction (height), multiplied by the number of features N, i.e. r²×N more pixels than each low resolution image frame Iₜ^{LR}. Consequently, J^{HR}∈ [symbol] ^{rH×rW×N}.

### Decoder

In step S4, the decoder having the neural network DN reconstructs the SR image Î₀^{SR} from the aggregated features J^{HR}

Î₀^{SR}=Decoder(J^{HR};Θ_{D})∈ [symbol] ^{rH×rW},

where Θ_{D} denotes the set of parameters of the decoder.

In an example, the decoder comprises 2 convolutional layers at the two ends of a series of 10 residual blocks with 64 features per layer. The last convolutional layer outputs one output from N=64 inputs. Each residual block has 2 other convolutional layer supplying N=64 features and supplies an output being equal to its input added to the 2 other convolutional layers applied to this input.

### Self-Supervised Learning

According to an embodiment, the method comprises minimizing a self-supervised loss [symbol] _{self} calculated between the super-resolved image Î₀^{SR} and the reference frame I₀^{LR}, in order to train the first neural network NN1, the second neural network NN2 and the decoder network DN.

According to an embodiment, the method comprises calculating the self-supervised loss [symbol] _{self}(Î₀^{SR}, I₀^{LR}) as

[symbol]

_{self}(Î₀^{SR},I₀^{LR})=∥D₂(Î₀^{SR})−I₀^{LR}∥₁

wherein D₂ is a subsampling operator that takes one pixel over two in each of a first direction of the super-resolved image Î₀^{SR} and of a second direction of the super-resolved image Î₀^{SR}, perpendicular to the first direction,

wherein ∥∥₁ is the L1 norm.

According to an embodiment, the super-resolved image Î₀^{SR} is equal to

Î₀^{SR}=Net({Iₜ^{LR},}ₜ₌₁^{T}, I₀^{LR}) as an output of the decoder network DN.

The proposed loss also can be adapted to train a network to produce a deconvolved output as:

[symbol]

_{self}(Î₀^{SR},I₀^{LR})=∥D₂(Î₀^{SR}*k′)−I₀^{LR}∥₁

where k′ denotes the kernel to be deconvolved (usually related to the optical system Point Spread function),

wherein ∥∥₁ is the L1 norm.

According to an embodiment, the method comprises

calculating the self-supervised loss [symbol] _{self}(Î₀^{SR}, I₀^{LR}) as

[symbol]

_{self}(Î₀^{SR},I₀^{LR})=∥D₂(Î₀^{SR}*k′)−I₀^{LR}∥₁

wherein D₂ is a subsampling operator that takes one pixel over two in each of a first direction of the super-resolved image direction of the super-resolved image direction of the super-resolved image Î₀^{SR} and of a second direction of the super-resolved image Î₀^{SR}, perpendicular to the first direction,

wherein k′ is a prescribed blur kernel,

wherein ∥∥₁ is the L1 norm.

According to an embodiment, the blur kernel has a spectrum whose attenuation in a frequency domain has a dimension equal to 1/f, wherein f is the frequency.

According to an embodiment, the blur kernel has a spectrum whose attenuation in a frequency domain is equal to

\hat{k}′(ω)=A·(B|ω|+1)⁻¹

wherein A is a first prescribed real number not null,

B is a second prescribed real number not null,

and ω=2π·f.

According to an embodiment, k′ is a blur kernel which can be defined for example as

\hat{k}′(ω)=(5|ω|+1)⁻¹.

From the formation model, we see that the LR images Iₜ^{LR} and the target high resolution image I^{HR} capture the same underlying image [symbol] ^{bl}, only the sampling and noise differs. During self-supervised training, LR sequences are randomly selected and for every sequence one frame is set apart as the reference I₀^{LR}. Then, all other LR images in each sequence are registered against I₀^{LR}. Assuming that the registration is perfect, the registered LR images correspond to noisy samples of [symbol] ^{bl}. Thus, ignoring the noise, I₀^{LR} could be used as target for the fraction of pixels it contains. That is, the proposed self-supervised loss aims at training the network to produce an image such that when subsampled, it coincides with the target I₀^{LR}. Following noise-to-noise, if the noise in the LR frames is independent, the network is unable to predict the noise in I₀^{LR} and it learns to output a noise-free image. The use of the L1 norm in the loss is adapted for frame-independent median preserving noise, as shown in the noise-to-noise framework.

Note that in the proposed architecture, the image I₀^{LR} is also an input of Net as the super-resolved image Î₀^{SR} has to be aligned with I₀^{LR}. Usually in self-supervised learning, the target is excluded from the network inputs during training in order to avoid trivial solutions. In our case, the network could achieve zero loss by learning to copy the reference LR frame I₀^{LR} in the subsampled pixels of the super-resolved image D₂(Î₀^{SR}). However, this is not a problem in our framework since the reference I₀^{LR} is only used to estimate the flows and does not enter the encoder path, thus the encoder and the decoder must learn to reproduce I₀^{LR} without having access to it. At test time, since the network has been trained to handle a variable number of input LR frames, the reference frame can be added to the inputs together with the rest of the LR frames. In conclusion, as long as the network architecture contains an explicit motion estimation module that is decoupled from the fusion module, our framework can be applied to provide self-supervised training.

According to an embodiment, the method comprises calculating a data attachment loss [symbol] _{data}

$${ℓ}_{data} ( {\hat{I}}_{0}^{SR} , {{I}_{t}^{LR}}_{t = 1 , … , T} ) = {λ}_{data} {\sum }_{t = 1}^{T} {‖ {Π}_{t} {\hat{I}}_{0}^{SR} - {I}_{t}^{LR} ‖}^{p}$$

wherein Πₜ is a sampling operator applied to the output super-resolved image Î₀^{SR},

∥∥^{p} is a norm p,

λ_{data} is a prescribed parameter.

Consequently, p controls the norm. For example, p can be equal to 1 or 2. The data attachment loss [symbol] _{data} will force the network to learn to stick to the input data. to an extent controlled by the parameter [symbol] _{data}.

The data attachment loss [symbol] _{data} is calculated to force the network to preserve more details present in the input images. Indeed, a side effect of the self-supervised loss is that it trains the network to predict a noise-free image. However, denoising is never perfect and some details can be lost due to denoising and the self-supervised loss cannot be used alone to modulate this effect. The proposed data attachment loss [symbol] _{data} enforces the fitting of the solution to the image formation model.

The data attachment loss [symbol] _{data} can be used in addition to the self-supervised loss.

According to an embodiment, the method comprises minimizing a motion estimation loss [symbol] ₘₑ calculated for each motion field F_{t→0}, ME between the top view image frames {Iₜ^{LR}}ₜ₌₁^{T} and the reference frame I₀^{LR}, in order to train the first neural network NN1.

According to an embodiment, the method comprises minimizing a motion estimation loss [symbol] ₘₑ calculated for each motion field F_{t→0}, ME between the top view image frames {Iₜ^{LR}}ₜ₌₁^{T} and the reference frame I₀^{LR}, in order to train at least the first neural network NN1, the second neural network NN2 and the decoder network DN.

According to an embodiment, the method comprises calculating the motion estimation loss [symbol] ₘₑ ({F_{t→0}}ₜ₌₁^{T}) as

$${ℓ}_{m e} ( {\{ {F}_{t \to 0} \}}_{t = 1}^{T} ) = {\sum }_{t = 1}^{T} {‖ {I}_{t}^{LR} - Pullback ( {I}_{0}^{LR} , {F}_{t \to 0} ) ‖}_{1} + {λ}_{1} TV ( {F}_{t \to 0} )$$

wherein Pullback(I₀^{LR}, F_{t→0}) computes a bicubic interpolation (or warping) of the reference frame I₀^{LR} according to the motion field F_{t→0},

TV is a finite difference discretization Total Variation regularizer, and

λ₁ is an hyperparameter controlling a regularization strength of the finite difference discretization Total Variation regularizer.

To ensure a good alignment of the LR frames, we use the motion estimation loss [symbol] ₘₑ consisting in a photo-consistency term and a regularization term, as the ones used for unsupervised training of optical flow. The loss [symbol] ₘₑ is computed for each flow F_{t→0}=ME(I₀^{LR}, ziₜ^{LR}, Θ_{ME}) estimated by the ME module:

To pre-train the motion estimation network we use the motion estimation loss [symbol] ₘₑ. For example, we initialize the weights of the motion estimator with Xavier's initialization according to the following document:

[21] Xavier Glorot and Yoshua Bengio: «Understanding the difficulty of training deep feedforward neural networks», Proceedings of the thirteenth international conference on artificial intelligence and statistics, pages 249-256, JMLR Work-shop and Conference Proceedings, 2010. In our experiments, we set λ₁ to 0.01 and batch size to 64, then use the following document:

[31] Diederik P Kingma and Jimmy Ba. Adam: «A method for stochastic optimization», arXiv preprint arXiv:1412.6980, 2014,

with the default Pytorch parameters and a learning rate of 10⁻⁴ to optimize the loss. The pre-training converges after 20 k iterations and takes about 5 hours on one NVIDIA V100 GPU.

According to an embodiment, the first neural network NN1 for estimating S1 the motion fields F_{t→1} between each top view image frames {Iₜ^{LR}}ₜ₌₁^{T} and the reference frame I₀^{LR} is trained before training together the first neural network NN1, the second neural network NN2 for encoding S1′ the top view image frames {Iₜ^{LR}}ₜ₌₁^{T} to produce the convolutional features {Jₜ^{LR}}ₜ₌₁^{T} extracted respectively from the top view image frames {Jₜ^{LR}}ₜ₌₁^{T} and the decoder network DN for decoding (in step S4) the aggregated features J^{HR} to produce the super-resolved image Î₀^{SR}. We first pre-train the motion estimator on our dataset, and then train the whole system end-to-end. While this is not strictly necessary, it stabilizes the training and accelerates the convergence.

According to an embodiment, the method comprises training together the first neural network NN1, the second neural network NN2 for encoding (in step S1′) the top view image frames {Iₜ^{LR}}ₜ₌₁^{T} to produce the convolutional features {Jₜ^{LR}}ₜ₌₁^{T} extracted respectively from the top view image frames {Iₜ^{LR}}ₜ₌₁^{T} and the decoder network DN for decoding (in step S4) the aggregated features J^{HR} to produce the super-resolved image Î₀^{SR} by minimizing a complete loss calculated as

loss= [symbol] _{self}+λ₂ [symbol] ₘₑ.

wherein [symbol] _{self} is a self-supervised loss calculated between the super-resolved image Î₀^{SR} and the reference frame I₀^{LR},

[symbol] ₘₑ is a motion estimation loss calculated for each motion field F_{t→0} between the top view image frames {Iₜ^{LR}}ₜ₌₁^{T} and the reference frame

λ₂ is a prescribed setting. The proposed self-supervised training relies on the minimization of the reconstruction loss [symbol] _{self} in the LR domain and of the motion estimation loss [symbol] ₘₑ to ensure accurate alignment.

After having pretrained the motion estimator network with the motion estimator loss [symbol] ₘₑ, we then train the entire system end-to-end using the complete loss. We set λ₂=10 in our experiments. The initial weights are set using He initialization according to the following document

[23] Kaiming He, Xiangyu Zhang, Shaoqing Ren, and Jian Sun: «Delving deep into rectifiers: Surpassing human-level performance on imagenet classification», Proceedings of the IEEE international conference on computer vision, pages 1026-1034, 2015,

except for the motion estimator whose initial weights are the pre-trained ones.

According to an embodiment, the method comprises calculating a self-supervised loss [symbol] _{supervised}(Î₀^{SR}, I^{HR}) as

[symbol]

_{supervised}(Î₀^{SR},I^{HR})=∥Î₀^{SR}−I^{HR}∥₁

wherein I^{HR} is a prescribed high resolution target, wherein ∥∥₁ is the L1 norm, minimizing the self-supervised loss [symbol] _{supervised} calculated between the super-resolved image Î₀^{SR} and the high resolution target I^{HR}, in order to train the first neural network NN1, the second neural network NN2 and the decoder network DN. For our experiments with simulated data, we also train a supervised model which is used as a reference (see below).

We train both supervised and self-supervised models on LR crops of size 64×64 pixels and validate on LR images of size 256×256 pixels. During training, our network is fed with a random number of LR input images (from 5 to 30) in each sequence. We set the batch size to 16 and optimize the loss using the Adam optimizer according to the above-mentioned Adam document [31] with default parameters. Our learning rates are initialized to 10⁻⁴ and scaled by a factor of 0.3 when the validation loss plateaus for more than 30 epochs. The training converges after 300 epochs and it takes about 18 hours on one NVIDIA V100 GPU.

FIG. 2a shows an overview of the proposed self-supervised MISR framework at training time. The loss depicted in FIG. 2a represents the self-supervision term [symbol] _{self}, for simplicity the losses concerning the motion estimator module are not illustrated. At inference time the frame I₀^{LR} is also encoded in this example and fed to the FS [symbol] A block. In FIG. 2b, SPMCx2 layer is illustrated: splattering LR features onto the HR domain using the flow F_{t→0} is shown.

### Experiments

In our experiments, we use real push-frame images acquired by satellites from the SkySat constellation. These images are also used to create a simulated dataset used for a quantitative evaluation.

### Datasets

### SkySat Imagery

The SkySat satellites contain a full-frame sensor capable of capturing 40 frames per second and is mainly operated in a push-frame mode with significant overlap between the frames. As a result, the same point on the ground is seen in at least 15 consecutive images. The individual low-resolution frames are called L1A products. Planet also provides a super-resolved product (called L1B) that corresponds to a ×1.25 zoom of the L1A images and has a resolution between 50 to 70 cm/pixel at nadir. It is important to note that the L1B product has also undergone an unknown sharpening, so it is not easily comparable to the L1A images.

### Simulated Dataset

A part of our experiments will be conducted on a simulated dataset generated from a set of crops of L1B products. For a given crop B, the ground truth HR image I^{HR} is computed by filtering B with a small Gaussian kernel with σ=0.3 so as to simulate a small optical blur. Random shifts (sampled uniformly on a disk) and a ×2 subsampling are then applied to I^{HR} to obtain the set of LR images

I₀^{LR}=D₂(I^{HR})+n₀,

Iₜ^{LR}=D₂(Shift _{Δ}_{ₜ}(I^{HR}))+nₜ, t=1, . . . , T,

where D₂ is the subsampling operator, Shift_{Δ}_{ₜ} applies a subpixel translation of Δₜ with Fourier interpolation (∥Δₜ∥₁≤2) to the image and nₜ models the noise.

Our simulated data was generated from 370 L1B images of size 3200×1350 pixels. We use 320 images for training and 50 for validation. From each image, random crops are extracted to generate bursts of 30 noisy LR frames with additive white Gaussian noise of standard deviation 3/255. The size of the crops in the training set is 64×64 pixels and in the validation set is 256×256 pixels.

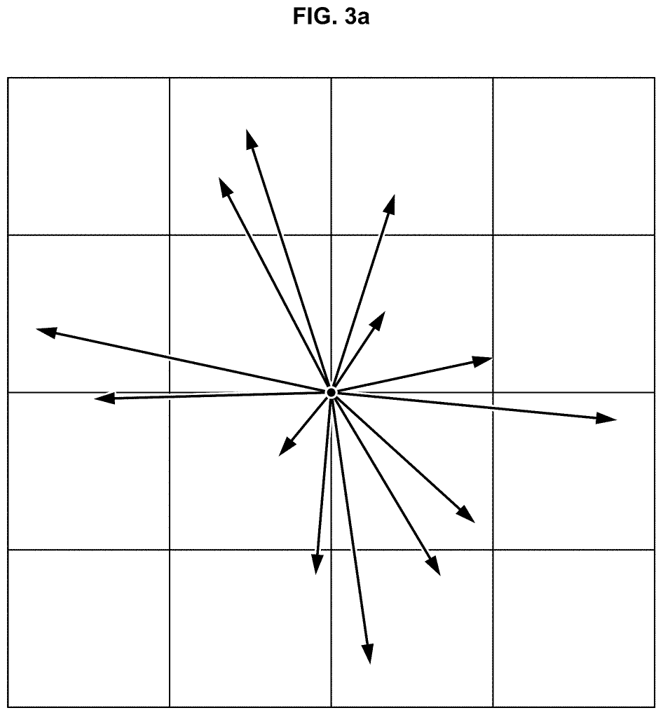

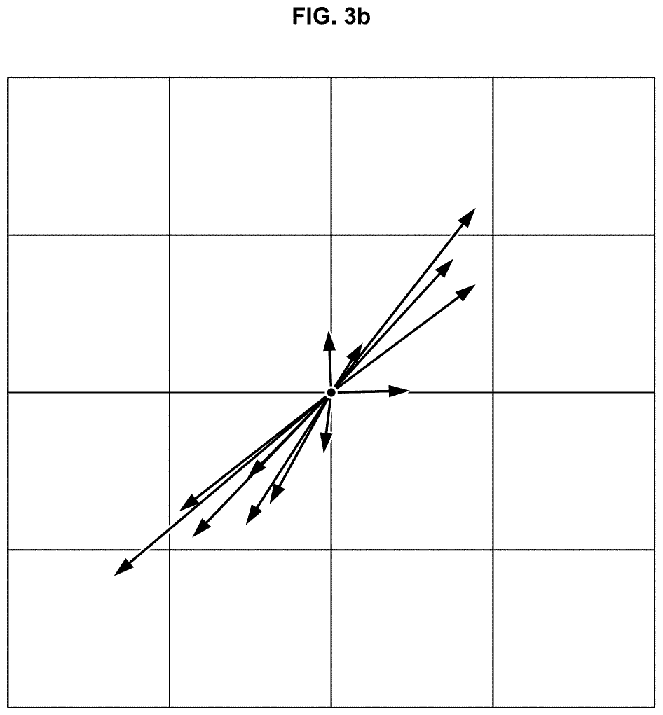

The relative position of the samples of the set of LR images is a critical aspect of the MISR problem. When the random shifts are drawn uniformly the restoration problem is usually well-posed. But, due to the motion of the satellite, real sampling configuration can be degenerate, i.e. with all the shifts aligned along the same direction. This is a critical situation for many traditional MISR algorithms that require additional regularization as the problem becomes ill-posed. Ignoring these degenerate configurations during training can result in poor performance in similar cases. Thus, in our main simulated dataset, we simulate a mixture of 80% uniform sampled sequences and 20% degenerate sampled sequences, in which the samples are allocated in a narrow ellipse as shown in FIG. 3a and FIG. 3b.

In FIGS. 3a and 3b, the vectors represent the global shifts between the LR frames in a simulated sequence. FIG. 3a represents uniform sampling, in which the shifts are uniformly distributed in a disk. FIG. 3b represents degenerate sampling, in which the shifts are distributed in a narrow ellipse.

We also generate datasets with 100% uniform and 100% degenerate samplings. We refer to them as mixed, uniform, and degenerate.

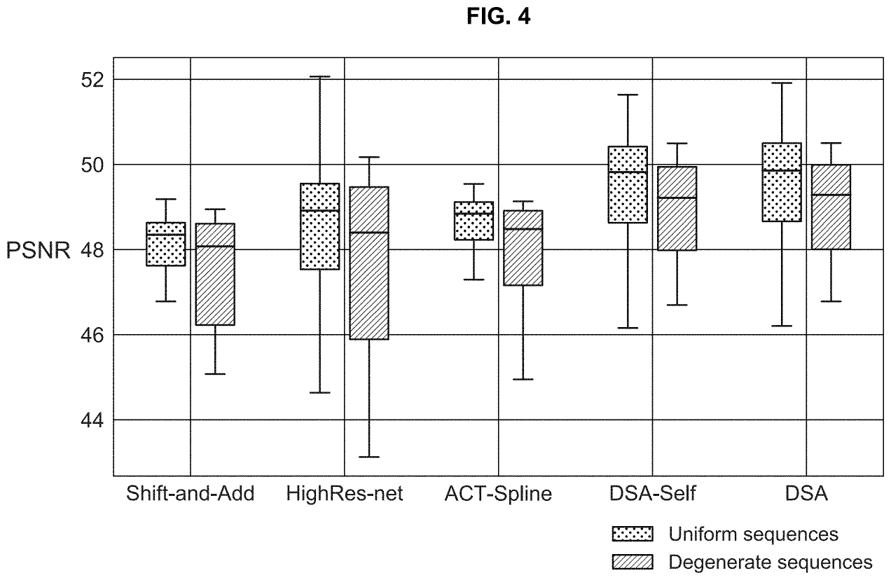

FIG. 4 shows the PSNR (peak signal to noise ratio) of different methods over our main validation set with 16 input frames per sequence, for uniform sequences on the left and degenerate sequences on the right.

DSA-Self-noref, DSA-Self and DSA represent embodiments according to the invention.

The Table 1 below shows the average PSNR over the validation dataset for different methods with different number of input images per sequence.

TABLE 1

| | Shift-and- | HighRes- | ACT- | DSA-Self- | DSA- | |
|---|---|---|---|---|---|---|
| Method | Add | net | Spline | noref | Self | DSA |
| T = 5 | 42.99 | 45.63 | 45.54 | 45.70 | 45.75 | 45.82 |
| T = 16 | 47.72 | 48.17 | 48.38 | 49.18 | 49.27 | 49.33 |
| T = 30 | 49.95 | 49.05 | 50.15 | 50.38 | 50.45 | 50.50 |

### Dataset of Real Images

For our experiments on real data, we selected 48 reference SkySat L1A images, and 15 frames overlapping each reference. The stacks of L1A images are pre-aligned to each reference with a discrete translation avoiding any resampling. From each reference image, we randomly crop 20 blocks of size 256×256 pixels, yielding 960 stacks of 15 frames in total, including 60 stacks for the validation set. For each stack, the L1B product from Planet is also extracted, which will only be used for visual comparison as we do not know which sharpening was used.

### Super-Resolution on Simulated Data

We evaluate the performance of our super-resolution network on the simulated dataset described above in FIG. 4 and table 1 and compare against three methods from the literature: Shift-and-Add, ACT-Spline and HighRes-net.

The classical Shift-and-Add with bilinear splattering will serve as baseline and is known in the following documents:

[41] Maria Teresa Merino and Jorge Nunez. Super-resolution of remotely sensed images with variable-pixel linear reconstruction. IEEE TGRS, 45(5):1446-1457, 2007,

[22] Thomas J Grycewicz, Stephen A Cota, Terrence S Lomheim, and Linda S Kalman. Focal plane resolution and overlapped array TDI imaging. In Remote Sensing System Engineering, volume 7087, page 708704. International Society for Optics and Photonics, 2008,

[3] Mohammad S Alam, John G Bognar, Russell C Hardie, and Brian J Yasuda. Infrared image registration and high-resolution reconstruction using multiple translationally shifted aliased video frames. IEEE Transactions on instrumentation and measurement, 49(5):915-923, 2000,

[26] Yunwei Jia. Method and apparatus for super-resolution of images, Nov. 6, 2012. U.S. Pat. No. 8,306,121.

ACT-Spline is a state-of-the-art method based on spline fitting and is known in the following document:

[5] Jérémy Anger, Thibaud Ehret, Carlo de Franchis, and Gabriele Facciolo. Fast and accurate multi-frame super-resolution of satellite images. ISPRS, 2020.

In Shift-and-Add and ACT-Spline, the LR images are aligned using the inverse compositional method and is known in the following documents:

[7] S. Baker and I. Matthews. Equivalence and efficiency of image alignment algorithms. In CVPR, 2001,

[10] Thibaud Briand, Gabriele Facciolo, and Javier Sánchez. Improvements of the Inverse Compositional Algorithm for Parametric Motion Estimation. IPOL, 8:435-464, 2018.

HighRes-net is a MISR CNN with implicit motion estimation trained originally for the PROBA-V challenge and is known in the following documents:

[13] Michel Deudon, Alfredo Kalaitzis, Israel Goytom, Md Ri-fat Arefin, Zhichao Lin, Kris Sankaran, Vincent Michal-ski, Samira E Kahou, Julien Cornebise, and Yoshua Ben-gio. Highres-net: Recursive fusion for multi-frame super-resolution of satellite imagery. arxiv 2020. arXiv preprint arXiv:2002.06460, 2020.

For HighRes-net we use a variant that was shown in the following document: [47] Ngoc Long Nguyen, Jérémy Anger, Axel Davy, Pablo Arias, and Gabriele Facciolo. Proba-v-ref: Repurposing the proba-v challenge for reference-aware super resolution. arXiv preprint arXiv:2101.10200, 2021,

to have a better performance on the PROBA-V-ref dataset.

We retrained HighRes-net with supervision on our simulated dataset, following the procedure of [47] but doubling the number of epochs to ensure convergence. As a reference for comparison with SISR methods, we also retrained SRGAN according to the following document

[35] Christian Ledig, Lucas Theis, Ferenc Huszár, Jose Caballero, Andrew Cunningham, Alejandro Acosta, Andrew Aitken, Alykhan Tejani, Johannes Totz, Zehan Wang, et al. Photo-realistic single image super-resolution using a generative adversarial network. In Proceedings of the IEEE conference on computer vision and pattern recognition, pages 4681-4690, 2017

on our dataset. As one could expect from a SISR method, many details are lost.

The above table 1 shows the results of the three methods plus our DSA network (with both supervised and self-supervised training) according to embodiments of the invention on the simulated validation set using 5, 16 and 30 input frames. FIG. 4 breaks down the performance of the different methods over the mixed validation dataset for the case with 16 input frames. Our supervised network ranks first, with a significant 0.95 dB gain (T=16) over ACT-Spline which was hand-tuned according to [5] on a dataset of SkySat images. HighRes-net performs 0.23 dB worse than ACT-Spline and this gap grows to 1.1 dB for T=30. The outputs of HighRes-net are noiseless but tend to be over-smoothed. It seems that for longer bursts, HighRes-net has problems fusing the complementary information of the LR frames. Note that HighRes-net was also trained by varying the number of LR frames. The DSA-Self-noref column shows the performance of our self-supervised network when the reference LR image I₀^{LR} is excluded from the fusion step at test time. In this case, we add an additional LR image to maintain the total number of LR images for a fair comparison. This shows that a small gain can be obtained by including I₀^{LR}.

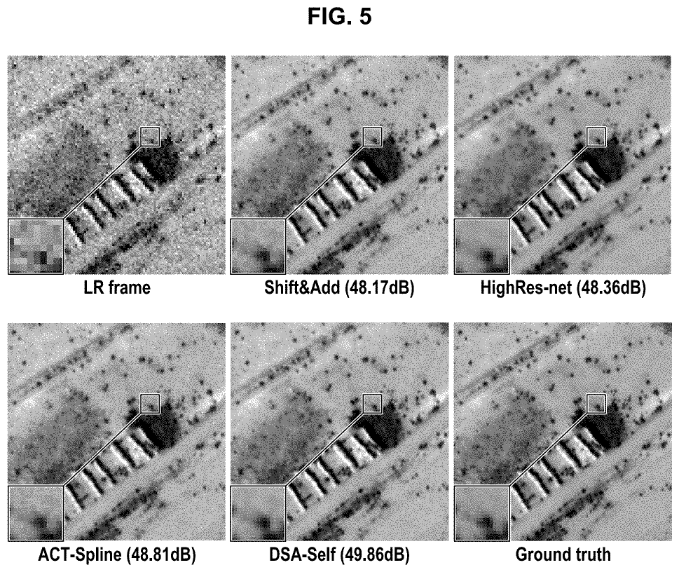

FIG. 5 presents a qualitative comparison between Shift-and-Add (48.17 dB), HighRes-net (48.36 dB), ACT-Spline (48.81 dB) and the proposed DSA-Self (49.86 dB) on a sequence of 16 frames from the validation set with uniform sampling of the shifts. The output of our supervised DSA (49.93 dB) was not included as it was indistinguishable to the DSA-Self result. In this example, DSA-Self outperforms the other methods by more than 1 dB. On the zoomed area, we can see that our method recovers faithfully the details on the ground. We remark that our network has never seen any ground truth HR image during training. It is optimized only by penalizing the loss between the downsampled version of the output and the noisy LR reference frame over a training dataset. On the other hand, the outputs of Shift-and-Add and ACT-Spline are noisy while the one produced by HighRes-net is too blurry and the black spots are barely distinguishable on the field.

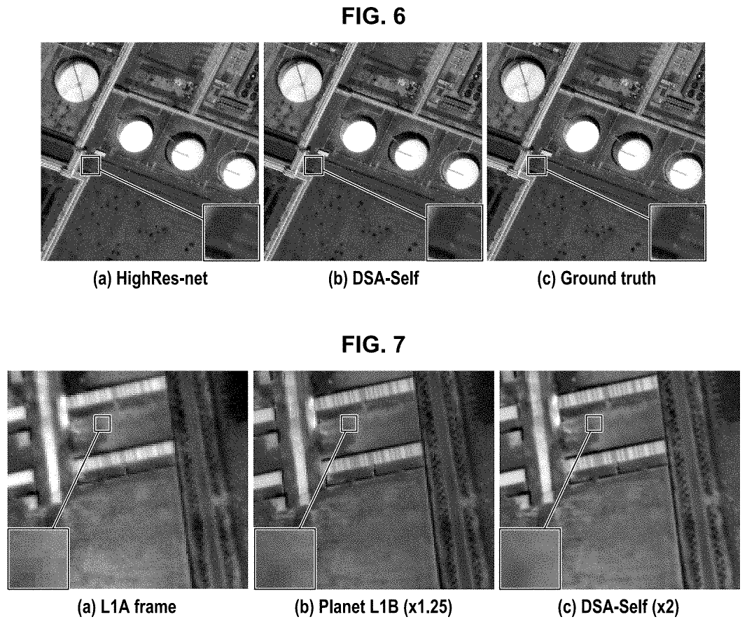

Reproducing the same experiment but with the degenerate samplings, we observe that HighRes-net fails to remove aliasing artifacts of the LR frames (see FIG. 6, in which HighRes-net reconstruction from a degenerate sequence of 16 frames presents strong aliasing artifacts), despite being trained with such configurations. We argue that the network was not able to exploit the alias in the images failing at increasing the resolution.

### Super-Resolution Trained on Real Data

We applied our framework to train our DSA-Self network on the dataset of real SkySat L1A bursts. Since there is no ground truth we conduct a qualitative evaluation comparing with the L1B product from Planet. We recall that our method estimates a high-resolution (but blurry) image sampled from [symbol] ^{bl}:= [symbol] *k, while the L1B product has undergone an unknown sharpening step.

As we do not know the optical characteristics of the SkySat satellites, following [5] we consider a blur kernel k′ such that when inverted, the reconstruction is visually well-contrasted. We model our blur kernel in the frequency domain as [symbol] (ω)=(5|ω|+1)⁻¹.

The sharp image could then be obtained by solving a variational non-blind deconvolution problem as in. Instead, we opt for incorporating the deconvolution in the self-supervision loss

[symbol]

_{self}(Î₀^{SR},I₀^{LR})=∥D₂(Î₀^{SR}*k′)−I₀^{LR}∥₁.

By embedding a deconvolution into the training, the network produces directly a sharp SR image without introducing unwanted high-frequency artifacts.

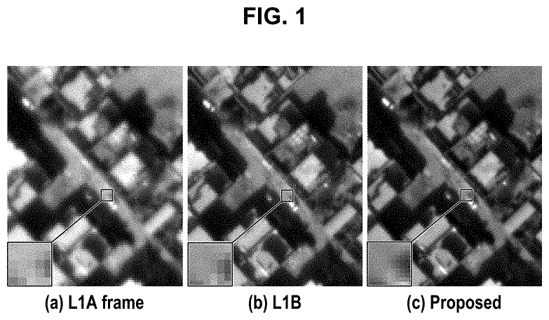

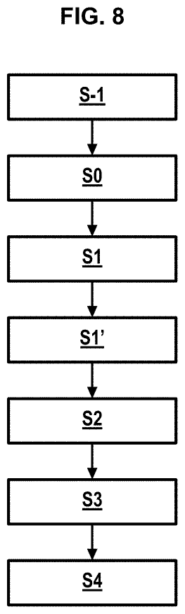

FIGS. 1 and 7 show side-by-side comparisons of results obtained on the validation dataset.

FIG. 1 shows super-resolution from a sequence of 15 real low-resolution SkySat L1A frames with (a) Reference L1a frame, (b) Planet L1B product (×1.25), (c) the proposed method (×2) according to the invention.

As we can see, L1B products present strong stair-casing artifacts. The fine details like the vehicle in the FIG. 1 and the vertical bars in the FIG. 7 are much sharper in the proposed method according to the invention.

At inference time, our proposed method takes 0.6 seconds to produce a ×2 super-resolved image from a sequence of 15 L1A images (256×256 pixels).

### Ablation Study

To analyze the importance of the different elements of the proposed architecture, we perform experiments in a supervised setting. First, we re-trained our DSA with different number of features produced by the encoder (4, 16 and 64) and evaluated on the 50 validation sequences comprising 16 images. The obtained PSNRs were respectively 48.81, 49.06 and 49.33 dB. Thus, 64 features yields the best results. We observed that more features led to diminishing returns. We also tested an architecture without encoder that directly aggregates pixels, but it under-performed with few input images.

Lastly, we studied the impact of training with a variable number of input images and considering degenerate sampling configurations. The four rows in Table 2 correspond to networks trained: 1. with a variable or a fixed (16) number of input images; 2. using the mixed or the uniform dataset. We evaluated the networks on the uniform, degenerate, and mixed test datasets using different number of input images (5, 16, 30). The table 2 is an evaluation of the impact of training the proposed DSA network with a variable number of input images (rows variable or a fixed (16) number of inputs) and considering degenerate sampling configurations or not (rows mixed or uniform datasets). The results show that training with a variable number of input images and with a mixed dataset leads to a network that is more resilient to having less input frames and that can cope with degenerate sampling configurations.

TABLE 2

| | | Testing on mixed dataset | | | | | | | | |
|---|---|---|---|---|---|---|---|---|---|---|
| Training | | Number of | | | Number of | | | Number of | | |
| Number of | Training | images | | | images | | | images | | |
| images | dataset | 5 | 16 | 30 | 5 | 16 | 30 | 5 | 16 | 30 |
| Variable | Mixed | 45.82 | 49.33 | 50.50 | 45.77 | 49.26 | 50.41 | 45.40 | 48.75 | 49.81 |
| Variable | Uniform | 45.78 | 49.27 | 50.43 | 45.79 | 49.31 | 50.39 | 45.34 | 48.68 | 49.74 |
| Fixed (16) | Mixed | 45.55 | 49.29 | 50.52 | 45.52 | 49.23 | 50.43 | 45.15 | 48.71 | 49.83 |
| Fixed (16) | Uniform | 45.32 | 49.16 | 50.52 | 45.37 | 49.20 | 50.49 | 44.94 | 48.59 | 49.81 |

### Conclusion

We presented a framework for the self-supervised training of multi-image super-resolution networks without requiring ground truth. For our framework to be applicable, the networks need an explicit motion compensation module. In addition, we proposed DSA, a novel MISR architecture consisting of a shift-and-add fusion of features. Our experiments on simulated data showed that the proposed self-supervision strategy attains state-of-the-art results, on par with those obtained with a supervised training. As our framework makes it possible to train a network solely from datasets of real LR images, we trained DSA on real SkySat satellite image bursts, leading to results that are more resolved and less noisy than the L1B product from Planet.

Recent constellations of optical satellites are adopting multi-image super-resolution (MISR) from bursts of push-frame images as a way to increase the resolution and reduce the noise of their products while maintaining a lower cost of operation. Most MISR techniques are currently based on the aggregation of samples from registered low resolution images. A promising research trend aimed at incorporating natural image priors in MISR consists in using data-driven neural networks. However, due to the unavailability of ground truth high resolution data, these networks cannot be trained on real satellite images. In this paper, we present a framework for training MISR algorithms from bursts of satellite images without requiring high resolution ground truth. This is achieved by adapting the recently proposed frame-to-frame framework to process bursts of satellite images. In addition we propose an architecture based on feature aggregation that allows to fuse a variable number of frames and is capable of handling degenerate samplings while also reducing noise. On synthetic datasets, the proposed self-supervision strategy attains results on par with those obtained with a supervised training. We applied our framework to real SkySat satellite image bursts leading to results that are more resolved and less noisy than the L1B product from Planet.

Of course, the aspects, embodiments, features, possibilities, steps, operations and examples of the disclosure mentioned above may be combined one with another or may be selected independently one from another.

1. A method for processing a sequence of top view image frames of low resolution of a same terrestrial location, each top view image frame having pixels and pixel values, comprising the following steps:
choosing one top view image frame, called reference frame, among the top view image frames,
estimating motion fields between each top view image frame and the reference frame by using a first neural network,
encoding the top view image frames to produce convolutional features extracted respectively from the top view image frames by using a second neural network,
aggregating pixels of the convolutional features to positions in a high resolution grid using the motion fields to obtain aggregated features,
decoding by a decoder network the aggregated features to produce a super-resolved image.

2. The method of claim 1, in which aggregating the pixels comprises:
computing the positions in the high resolution grid from the motion fields and from the pixels of the convolutional features.

3. The method of claim 1, in which aggregating the pixels comprises:
computing the positions in the high resolution grid as subpixel positions relatively to the pixels of the convolutional features.

4. The method of claim 1, in which aggregating the pixels comprises:
upscaling the convolutional features of each top view image frame by adding second subpixel positions having zero values between at least some of the pixels of the convolutional features in the high resolution grid.

5. The method of claim 3, in which aggregating the pixels comprises:
computing the subpixel positions as being the closest from the pixels of the convolutional features having been shifted by the motion fields in the high resolution grid.

6. The method of claim 5, in which aggregating the pixels comprises:
computing subpixel values at the subpixel positions in the high resolution grid,
wherein for each pixel of the convolutional features the subpixel value at each subpixel position is a weighted average of a value of the pixel of the convolutional features,
computing the aggregated features depending on the weighted average.

7. The method of claim 6, comprising
computing the weighted average of the value of the pixel of the convolutional features at each subpixel position of the high resolution grid using prescribed bilinear weights, which are applied to the value of the pixel of the convolutional features and which are calculated depending on a distance calculated between the pixels of the convolutional features having been shifted by the motion fields in the high resolution grid and the subpixel position.

8. The method of claim 7, comprising
calculating the prescribed bilinear weights as being a decreasing function of the distance calculated between the pixels of the convolutional features having been shifted by the motion fields in the high resolution grid and the subpixel position in the high resolution grid.

9. The method of claim 7, in which for each pixel of the convolutional features the subpixel positions comprise:
a first subpixel position having in the high resolution grid a first abscisssa x₁₁ and a first ordinate y₁₁,
a second subpixel position having in the high resolution grid a second abscisssa x₂₁, which is equal to the first abscisssa x₁₁ plus an abscissa pitch p′ₓ of the high resolution grid, and a second ordinate y₂₁, which is equal to the first ordinate y₁₁,
a third subpixel position, having in the high resolution grid a third abscisssa x₁₂, which is equal to the first abscisssa x₁₁, and a third ordinate y₁₂, which is equal to the first ordinate y₁₁ plus the ordinate pitch p′_{y},
a fourth subpixel position, having in the high resolution grid a fourth abscisssa x₂₂, which is equal to the first abscisssa x₁₁ plus the abscissa pitch p′ₓ, and a fourth ordinate y₂₂, which is equal to the first ordinate y₁₁ plus the ordinate pitch p′_{y},
each pixel of the convolutional features having been shifted by the motion fields in the high resolution grid having a fifth abscisssa xₛ and a fifth ordinate yₛ,
wherein
w₁₁=x₂/(2·p′ₓ)+y₂/(2·p′_{y})
w₂₁=x₁/(2p′ₓ)+y₂/(2·p′_{y})
w₁₂=x₂/(2·p′ₓ)+y₁/(2·p′_{y})
w₂₂=x₁/(2·p′ₓ)+y₁/(2·p′_{y})
x₁=xₛ−x₁₁
x₂=x₂₁−xₛ
y₁=yₛ−y₁₁
y₂=y₂₁−yₛ.

10. The method of claim 6, comprising
computing the aggregated features being proportional to weighted average.

11. The method of claim 9, comprising
computing the aggregated features J^{HR} as
J^{HR}=(ΣₜJₜ^{HR})(ΣₜWₜ^{HR})⁻¹
wherein Wₜ^{HR}=SPMC(1, {F_{t→0}}) are the sum of the prescribed bilinear weights affecting the values of the pixels of the convolutional features {Jₜ^{LR}}ₜ₌₁^{T}.

12. The method of claim 1, comprising
minimizing a self-supervised loss calculated between the super-resolved image and the reference frame, in order to train the first neural network, the second neural network and the decoder network.

13. The method of claim 12, comprising
calculating the self-supervised loss [symbol] _{self}(Î₀^{SR}, I₀^{LR}) as [symbol]
_{self}(Î₀^{SR},I₀^{LR})=∥D₂(Î₀^{SR})−I₀^{LR}∥₁
wherein D₂ is a subsampling operator that takes one pixel over two in each of a first direction of the super-resolved image Î₀^{SR} and of a second direction of the super-resolved image Î₀^{SR}, perpendicular to the first direction,
wherein ∥∥₁ is the L1 norm.

14. The method of claim 13, wherein the super-resolved image is equal to
Î₀^{SR}=Net({Iₜ^{LR},}ₜ₌₁^{T}, I₀^{LR}) as an output of the decoder network.

15. The method of claim 12, comprising
calculating the self-supervised loss [symbol] _{self}(Î₀^{SR}, I₀^{LR}) as [symbol]
_{self}(Î₀^{SR},I₀^{LR})=∥D₂(Î₀^{SR}*k)−I₀^{LR}∥₁
wherein D₂ is a subsampling operator that takes one pixel over two in each of a first direction of the super-resolved image direction of the super-resolved image direction of the super-resolved image Î₀^{SR} and of a second direction of the super-resolved image Î₀^{SR}, perpendicular to the first direction,
wherein k′ is a prescribed blur kernel,
wherein ∥∥₁ is the L1 norm.

16. The method of claim 15, wherein the prescribed blur kernel has a spectrum whose attenuation in a frequency domain has a dimension equal to 1/f, wherein f is the frequency.

17. The method of claim 1, comprising calculating a data attachment loss [symbol] _{data}
$${ℓ}_{data} ( {\hat{I}}_{0}^{SR} , {{I}_{t}^{LR}}_{t = 1 , … , T} ) = {λ}_{data} {\sum }_{t = 1}^{T} {‖ {Π}_{t} {\hat{I}}_{0}^{SR} - {I}_{t}^{LR} ‖}^{p}$$
wherein Πₜ is a sampling operator applied to the output super-resolved image Î₀^{SR}, ∥∥^{p} is a norm p,
λ_{data} is a prescribed parameter.

18. The method of claim 1, comprising
minimizing a motion estimation loss calculated for each motion field between the top view image frames and the reference frame, in order to train the first neural network.

19. The method of claim 1, comprising
minimizing a motion estimation loss calculated for each motion field between the top view image frames and the reference frame, in order to train at least the first neural network, the second neural network and the decoder network.

20. The method of claim 18, comprising
calculating the motion estimation loss [symbol] ₘₑ({F_{t→0}}ₜ₌₁^{T}) as
$${ℓ}_{m e} ( {\{ {F}_{t \to 0} \}}_{t = 1}^{T} ) = {\sum }_{t = 1}^{T} {‖ {I}_{t}^{LR} - Pullback ( {I}_{0}^{LR} , {F}_{t \to 0} ) ‖}_{1} + {λ}_{1} TV ( {F}_{t \to 0} )$$
wherein Pullback(I₀^{LR}, F_{t→0}) computes a bicubic interpolation of the reference frame I₀^{LR} according to the motion field F_{t→0},
TV is a finite difference discretization Total Variation regularizer, and
λ₁ is an hyperparameter controlling a regularization strength of the finite difference discretization Total Variation regularizer.

21. The method of claim 1, in which
the first neural network for estimating the motion fields between each top view image frames and the reference frame is trained before training together the first neural network, the second neural network for encoding the top view image frames to produce the convolutional features extracted respectively from the top view image frames and the decoder network for decoding the aggregated features to produce the super-resolved image.

22. The method of claim 21, comprising
training together the first neural network, the second neural network for encoding the top view image frames to produce the convolutional features extracted respectively from the top view image frames and the decoder network for decoding the aggregated features to produce the super-resolved image by minimizing a complete loss calculated as
loss= [symbol] _{self}+λ₂ [symbol] ₘₑ.
wherein [symbol] _{self} is a self-supervised loss calculated between the super-resolved image and the reference frame, [symbol]
ₘₑ is a motion estimation loss calculated for each motion field between the top view image frames and the reference frame,
λ₂ is a prescribed setting.

23. The method of claim 1, comprising
calculating a self-supervised loss [symbol] _{supervised}(Î₀^{SR}, I^{HR}) as [symbol]
_{supervised}(Î₀^{SR},I^{HR})=∥Î₀^{SR}−I^{HR}∥₁
wherein I^{HR} is a prescribed high resolution target,
wherein ∥∥₁ is the L1 norm,
minimizing the self-supervised loss calculated between the super-resolved image Î₀^{SR} and the high resolution target I^{HR}, in order to train the first neural network, the second neural network and the decoder network.

24. The method of claim 1, comprising
filtering beforehand the top view image frame and the reference frame by a Gaussian filter.

25. A device for processing a sequence of top view image frames of low resolution of a same terrestrial location, each top view image frame having pixels and pixel values, comprising:
a calculator to choose one top view image frame, called reference frame, among the top view image frames,
a first neural network for estimating motion fields between each top view image frames and the reference frame,
a second neural network for encoding the top view image frames to produce convolutional features extracted respectively from the top view image frames,
the calculator being configured to aggregate pixels of the convolutional features to positions in a high resolution grid using the motion fields to obtain aggregated features,
a decoder network for decoding the aggregated features to produce a super-resolved image.

26. A non-transitory computer-readable storage medium having instructions thereon that, when executed by a processor, cause the processor to execute operations for processing a sequence of top view image frames of low resolution of a same terrestrial location, each top view image frame having pixels and pixel values, the operations comprising
choosing one top view image frame, called reference frame, among the top view image frames,
estimating motion fields between each top view image frames and the reference frame by using a first neural network,
encoding (S1′) the top view image frames to produce convolutional features extracted respectively from the top view image frames by using a second neural network,
aggregating pixels of the convolutional features to positions in a high resolution grid using the motion fields to obtain aggregated features,
decoding by a decoder network the aggregated features to produce a super-resolved image.

27. The method of claim 19, comprising
calculating the motion estimation loss [symbol] ₘₑ({F_{t→0}}ₜ₌₁^{T}) as
$${ℓ}_{m e} ( {\{ {F}_{t \to 0} \}}_{t = 1}^{T} ) = {\sum }_{t = 1}^{T} {‖ {I}_{t}^{LR} - Pullback ( {I}_{0}^{LR} , {F}_{t \to 0} ) ‖}_{1} + {λ}_{1} TV ( {F}_{t \to 0} )$$
wherein Pullback(I₀^{LR}, F_{t→0}) computes a bicubic interpolation of the reference frame I₀^{LR} according to the motion field F_{t→0},
TV is a finite difference discretization Total Variation regularizer, and
λ₁ is an hyperparameter controlling a regularization strength of the finite difference discretization Total Variation regularizer.
